(19) United States
(12) Patent Application Publication
(10) Pub. No.: US 2006/0293089 A1
(43) Pub. Date: Dec. 28, 2006

(54) System and method for automatic creation of digitally enhanced ringtones for cellphones

(75) Inventors: Tilman Herberger, Dresden (DE); Titus Tost, Dresden (DE)

Correspondence Address: FELLERS SNIDER BLANKENSHIP;BAILEY & TIPPENS, THE KENNEDY BUILDING, 321 SOUTH BOSTON SUITE 800, TULSA, OK, 74103-3318, US

(73) Assignee: MAGIX AG

(21) Appl. No.: 11/158,380

(22) Filed: Jun. 22, 2005

(51) Int. Cl. H04B 1/38; H04M 1/00

(52) U.S. Cl. 455/567

(57) ABSTRACT

There is provided herein a system and method for automatically enhancing or creating ringtones for use on cellular phones. In the preferred embodiment, a user will be able to create an enhanced ringtone that is recognizable and distinct when played via a cell phone. The user will preferably begin by selecting the input audio material. An automatic analysis of the audio material is preferably conducted in order to determine a synthetic tone series that best represents it. An enhanced ringtone is then created by combining the original audio material with the tone series to form a unified audio work. The instant invention is primarily intended for use with cell phones but would also be useful elsewhere and this is especially so where the device that plays the enhanced audio material has limited audio capabilities.

### FIELD OF THE INVENTION

The present invention relates generally to the field of digital audio processing and mobile cell phones. More particularly, but not by way of limitation, the present invention relates to processes that provide a cell phone user with an enhanced ringtone or other audio experience.

### BACKGROUND OF THE INVENTION

The cell phone has become a fixture in the homes and offices of most U.S. and many foreign consumers. As might be expected, the pursuit of consumers in this growing market has driven the providers of cellular telephones to offer a continuing profusion of new products and features that are designed to differentiate each company's product from the others and to entice the consumer to buy a particular brand of hardware. Market dynamics have resulted in a steady evolution of cell phones from single purpose communication devices into multimedia hubs that enable the user to capture video sequences, take pictures, listen to radio, play games, view and hear multimedia files, etc. Additionally, recent technological advances have made it possible for cell phone users to connect to and browse the Internet and to replicate many of the functions that a desktop PC Internet user is accustomed to having at his or her disposal.

Of course, the present stage of cell phone evolution did not take place over night. Rather there has been a continuous series of changes in cell phone features and capabilities as such phones evolved from the unwieldy bag phone of yesterday to today's modern compact phones that are not much larger than a candy bar. The trend toward smaller phone size, however, has been slowed somewhat by the decision to include features beyond basic telephony in many cell phones (e.g., cameras, PDA functionality, GPS mapping, etc.) and, similarly, by the perceived need to include ever increasing levels of multimedia functionality including both recordation and playback.

In addition to the afore-mentioned hardware feature explosion, there has also been a similar trend toward increasing the amount of customization that users can apply to their phones. Early examples of user customization include after market cell phone case parts and bags. Today, however, the customization trend has taken a more technological turn and companies are increasingly allowing users to modify the cell phone operating system by, for example, selecting a background wallpaper for the LCD display, choosing a boot screen, assigning photo caller I.D.s, (using images that might be created by a cell phone digital camera), selecting custom ring tones, etc.

Of the foregoing, the selection and/or creation of cell phone ringtones has the potential to be one of the more lucrative customization trends. Of course, those of ordinary skill in the art will understand that, in simplest terms, ringtones are audio files that are played to notify a user of an incoming call or other cell phone event (e.g., receipt of a text message, notification of a waiting voice mail message, etc.). These files might contain digital audio information (e.g., MP3, WAV, etc.), MIDI based tones, etc. More recently, ringtones have been used to differentiate the originator of incoming calls (e.g., certain callers get special rings) rather than being applied universally to all incoming calls.

Users have for some time been able to design and install their own ringtones. These users might utilize general-purpose audio editing software or, more rarely, software provided by the manufacturer specifically for the purpose of creating ringtones. User-designed ringtones were often made freely available on the Internet where they could be downloaded and/or traded. However, one problem with many of the early user-designed ringtones is that they tended to be of relatively low audio quality e.g., they were often monophonic ringtones, i.e., ringtones that consisted of a series of simple single-note “beeps”.

Manufacturers have been quick to respond to the users' demand for higher fidelity MP3-type ringtones and especially polyphonic ringtones those that are based on popular songs, sound effects, etc. Polyphonic ringtones are complex tones that can recreate the sound of multiple instrument voices being played simultaneously. Polyphonic ringtones often take the form of MP3 (or similar) digitally recorded music or other audio files. In other variations, a polyphonic ringtone might be comprised of MIDI notes, wherein multiple MIDI notes are designed to be played simultaneously.

Of course, even when the ringtone source material is high fidelity the ringtone might still appear to be of low fidelity when played through the small audio speaker that is typically found in cellular telephones. There are many reasons why cell phones do not contain high fidelity speakers but one of the more obvious is that this would be in opposition to the steadily shrinking size of such devices. That is, generally speaking the larger the speaker the more faithful the reproduction of the sounds that is played therethrough and users are increasingly demanding small cellular phones for their ease in transportation and storage.

Further, although the creation of monophonic ring tones might be within the capability of many non-technical users, the technology level and time required to create a good-sounding polyphonic tone might be beyond many users' ability levels.

A number of companies have recognized the market opportunity represented by the sale of custom ringtones. Typically, such tones are purchased by the user by dialing a manufacturer-provided telephone number or by requesting via the Internet that such tones be sent to the user's cell phone number. The market for ringtones has quickly developed into a multi-million dollar industry, wherein users can buy either subscription packets of tones or individual ringtones depending on their tastes and budgets.

However, recent hardware introductions have raised some doubts that users will rely as much on purchased ringtones in the future. This is because, among other reasons, the newest generation of cell phones support virtually any form of audio file that can be played on a PC and the closer integration between phones and PCs makes possible easy transfer of audio files from a user's desktop or laptop to the cell phone. Additionally, phones with built-in Bluetooth or other wireless networking abilities have reduced the need for users to ask the phone company to transmit ringtones to their phones. Instead, the user can just do it him or her self.

The tighter integration between cell phones and PCs has made it natural for users to want to transfer music tracks—or portions thereof—from their favorite CDs to their phones for use as ringtones, thereby avoiding the cost of purchasing the same music again from a provider. However, this conceptually simple operation has certain problems associated with it. For one, the quality of user-created ringtones is usually not at the same level as the quality level of the source material (e.g., the sample rate may need to be reduced from about 44 kHz to, for example, 8 kHz), which tends to discourage users who expect their ringtones to be of the same fidelity as their input source. For another, the loudspeaker in a cell phone is capable of reproducing only a narrow range of frequencies as compared with a home stereo system or a pair of good headphones. Thus, even a correctly sampled and edited ringtone may sound distorted or “tinny” when played through the cell phone speaker. Indeed, in some cases, a user-created ringtone may prove to be unrecognizable when it is actually put into use. Finally, because of the poor quality of the sound that is actually heard by the user, in many cases the user-created ringtone may not serve its intended purpose, i.e., that of signaling the user that a call is incoming. For example, in situations where there is significant environmental noise (e.g., live sporting events, bars, etc.) the sound produced by the phone may not be distinctive enough to even be recognized.

Thus, what is needed is a method that enables a user to create ringtones from audio material wherein the user will have some confidence that the resulting tone will be recognizable when it is actually put into use. Further, a method is needed that creates a ringtone that will be distinct enough so that when it is played through a cell phone or other small speaker it will be able to draw the user's attention in even noisy environments. Additionally, a method is needed that will allow a user to create such ringtones automatically and have the process of creation and transfer to the phone be carried out with minimal user interaction. Finally, a method is needed that allows the user to enhance pre-existing ringtones that are currently stored in the cell phone's memory to make them more recognizable and distinct.

Accordingly it should now be recognized, as was recognized by the present inventors, that there exists, and has existed for some time, a very real need for a system and method that would address and solve the above-described problems.

Before proceeding to a description of the present invention, however, it should be noted and remembered that the description of the invention which follows, together with the accompanying drawings, should not be construed as limiting the invention to the examples (or preferred embodiments) shown and described. This is so because those skilled in the art to which the invention pertains will be able to devise other forms of the invention within the ambit of the appended claims.

### SUMMARY OF THE INVENTION

There is provided herein a system and method of automatically enhancing or creating ringtones for use on cellular phones. In the preferred embodiment, a user (to include, without limitation, a commercial ringtone provider) will be able to create audio material that is suitable for use on a cellular phone and that is recognizable and distinct when played via that device. The instant invention is primarily intended for use within the cell phone/ringtone market, but would also be useful in other situations, and this is especially so where the device that plays the prepared audio material has limited audio capabilities.

In brief, the instant invention enables the user to create enhanced ringtones from of a variety of different digital input formats and/or to enhance existing ringtones. By enhancement, the instant inventors mean making a modification or augmentation of the original ringtone that is designed to improve its recognizability and/or distinctiveness when played through a relatively low fidelity speaker such as might be found in a conventional cellular telephone. The enhanced ringtones will preferably be created by using a PC or other general purpose computer (to include handhelds, and other small computers) and then transferred to the cell phone where it can be played as needed.

According to a first preferred embodiment, there is provided a method of enhancing audio material that preferably begins with the selection of source material by a user. The source material might be found, by way of example only, within a track of an audio CD, or it might be a digital file that could potentially be in any audio format (e.g., MP3, WAV, etc.). The audio source material could also originate from within the cell phone itself, in the event that a user wishes to enhance a previously loaded ringtone.

As a next step the user will preferably designate a portion of the selected audio material to use as a ringtone. Obviously, the user's designation could include the entirety of the audio material. However, selecting the entire audio material to function as a ringtone might be impractical where the phone has limited internal and/or external memory. In many cases, the user will be asked to limit the amount of material that is selected to, say, about 30 seconds in length. However, preferably the user will not be so-limited.

As a next preferred step, the instant invention will extract the portion of the audio work that has been selected by the user. Preferably, the user will be able to review and modify the extracted base ringtone before proceeding to the next step.

Next, an analysis of the user's selected input audio material will preferably be performed. One central goal of this analysis is to identify the rhythmic and harmonic characteristics of the base ringtone. Preferably, the analysis will be carried out automatically without a need for intervention or other input from the user.

Although the analysis of the base ringtone might be conducted in many ways, in one preferred embodiment as a first step an automatic beat detection algorithm will be applied. The results of this step will provide a beat grid for use in the steps that follow. As a next preferred step in the analysis, a continuous harmonic analysis will be performed. Next, the information from the beat and harmonic analyses will be combined to produce a framework that generally represents the melody, chord structure, and beat structure of the input audio work.

The results of the previous analyses are then preferably dynamically optimized as described hereinafter. The output from this step will be a collection of individual notes that, together with the occurrence time of each note and its duration, in some sense best represents some aspect of the base ringtone. For example, in some instances the notes might track the melody. In others, the notes could represent some other aspect of the audio work such as the harmony, the rhythm section, a particular instrument, the fundamental note in an identified chord, etc. Either way, in the preferred embodiment the results of this step are then used to place notes at each of the note locations identified above. Note that there is no requirement that the note collection exclusively tracks one aspect of the music. In one preferred arrangement, the note collection might track the melody at one point, the rhythm at another point, etc. Preferably, the note collection will be in some sense a best single-note (monophony) representation of the base ringtone. Finally, in some preferred embodiments the sequence of tones will be represented in the form of series of standard MIDI events.

Preferably, the time locations that have been identified will be visually displayed within a graphical user interface (“GUI”, hereinafter) that is used to implement the instant invention. Further, in some preferred arrangements the user will be allowed to manually edit the computer-selected time locations and note values.

As a next preferred step, the instant invention will create simple synthetic tones that are to be incorporated into the selected audio material at the locations that have been determined during the analysis step. Preferably, the synthetic tones will be created by selecting a “voice” which is to be sounded by the notes (e.g., a sampled piano, a synthetic horn, a square wave, etc.). In some embodiments the user will be allowed to select the voice that is used to sound the notes.

Note that by creating synthetic tones that are to be added to/played in concert with the original work the most salient features of that work will have been emphasized (e.g., the melody will have been doubled), thereby increasing the likelihood that the source audio work will be recognizable to a user. Note that in one preferred embodiment the synthetic tones will be selected so as to reinforce the melody (and its associated rhythm) of the base ringtone.

Additionally, in some preferred embodiments the tones that are generated will be pitched differently (e.g., 2 octaves higher) than the actual notes that have been identified in the audio material. This is done so that the frequency of the synthetic tones will tend to lay close to or within the frequency band that is optimal for many cellular telephone speakers, e.g., between about 1000 Hz and 3000 Hz. By choosing the tones in this manner, the resulting combination (base ringtone plus additional tones) will tend to be much more identifiable and distinct than the original work playing alone would have been.

As a next preferred step, the instant invention will create a digital sequence from the synthetic tones and this sequence will be added to the input audio work, thereby creating an enhanced ringtone. The enhanced ringtone will then preferably be automatically stored on a users computer for further editing or transfer to the users cell phone.

As a next preferred step, the user will be given the option of transferring the enhanced ringtone to a cell phone. If the user decides to—take this step, the instant invention will preferably transmit the enhanced ringtone to the cell phone using one of any number of transmission variants including, for example, transfer via infrared transmission, Bluetooth, data cable, etc. After the enhanced ringtone is received within the phone, the user will typically select it for use according to methods provided by the phone operating system.

In another embodiment, the user will enhance an existing ringtone by, first, reading it from the user's phone, analyzing it as has been described previously, adding synthetic tones per the analysis, and transmitting the resulting audio work back to the phone. In this case, it may not be necessary to make a selection from within the exiting ringtone, as the user will likely be satisfied with the existing ringtone's original length.

In yet another embodiment, the instant invention will maintain the synthetic tone file (e.g., a MIDI file and a voice selection) and a digital audio file (e.g., an MP3 file) separately. They might both then be transmitted to the cellular telephone and combined within that device either before storing them or dynamically when the phone needs to signal an incoming call or other event.

It should be clear that an approach such as that disclosed herein would be a tremendous benefit to the cell phone user and would make it possible for users of every skill level to quickly create enhanced ringtones from his or her favorite music tracks or any other digital source. Further, the user would have some confidence that the resulting enhanced ringtone would be identifiable when played through his or her cell phone speaker. The instant invention allows the user to create high quality ringtones in a very short time without requiring any specific technical or musical knowledge.

The foregoing has outlined in broad terms the more important features of the invention disclosed herein so that the detailed description that follows may be more clearly understood, and so that the contribution of the instant inventors to the art may be better appreciated. The instant invention is not limited in its application to the details of the construction and to the arrangements of the components set forth in the following description or illustrated in the drawings. Rather the invention is capable of other embodiments and of being practiced and carried out in various other ways not specifically enumerated herein. Additionally, the disclosure that follows is intended to apply to all alternatives, modifications and equivalents as may be included within the spirit and the scope of the invention as defined by the appended claims. Further, it should be understood that the phraseology and terminology employed herein are for the purpose of description and should not be regarded as limiting, unless the specification specifically so limits the invention. Further objects, features and advantages of the present invention will be apparent upon examining the accompanying drawings and upon reading the following description of the preferred embodiments.

### BRIEF DESCRIPTION OF THE DRAWINGS

Other objects and advantages of the invention will become apparent upon reading the following detailed description and upon reference to the drawings in which:

FIG. 1 illustrates a preferred environment for the instant invention.

FIG. 2 illustrates a preferred GUI in a first phase of the instant invention.

FIG. 3 illustrates a preferred GUI of the instant invention in a second phase.

FIG. 4 depicts a preferred GUI at a third phase of the instant invention.

FIG. 5 depicts a preferred GUI at a fourth phase of the instant invention.

FIG. 6 illustrates a preferred GUI of the instant invention after selection of the base ringtone by a user.

FIG. 7 depicts a preferred GUI of the instant invention displaying the base ringtone together with the automatically determined time locations for the synthetic tones.

FIG. 8 illustrates a preferred GUI of the instant invention prior to the transmission step of the created enhanced ringtone.

FIG. 9 depicts a preferred GUI of a cell phone using the instant invention showing the reception of the transferred enhanced ringtone.

FIG. 10 contains a flowchart which illustrates some preferred steps of the instant invention

### DESCRIPTION OF THE PREFERRED EMBODIMENTS

Referring now to the drawings, wherein like reference numerals indicate the same parts throughout the several views, there is provided a preferred system and method for automatically creating and enhancing cellular ringtones so that the enhanced ringtones are more readily identified and/or discerned by, for example, a user who receives a call in a noisy environment.

By way of general explanation and in accord with the preferred embodiment, it is to be understood that when the term “enhancing ringtones” is used herein that phrase will preferably be interpreted to mean augmenting a digital sound source (whether MP3, WAV, AIFF, etc.) by creating a series of synthetic tones that are intended to emphasize some aspect of the original sound source and then playing the tone series simultaneously with the original digital sound file. The instant invention will preferably be implemented on a users computer and will be designed to make it easy for a user to create such enhanced ringtones and move them onto a cell phone via, for example, Bluetooth, Wi-Fi, a cable connection to the host computer, or via a phone company's network.

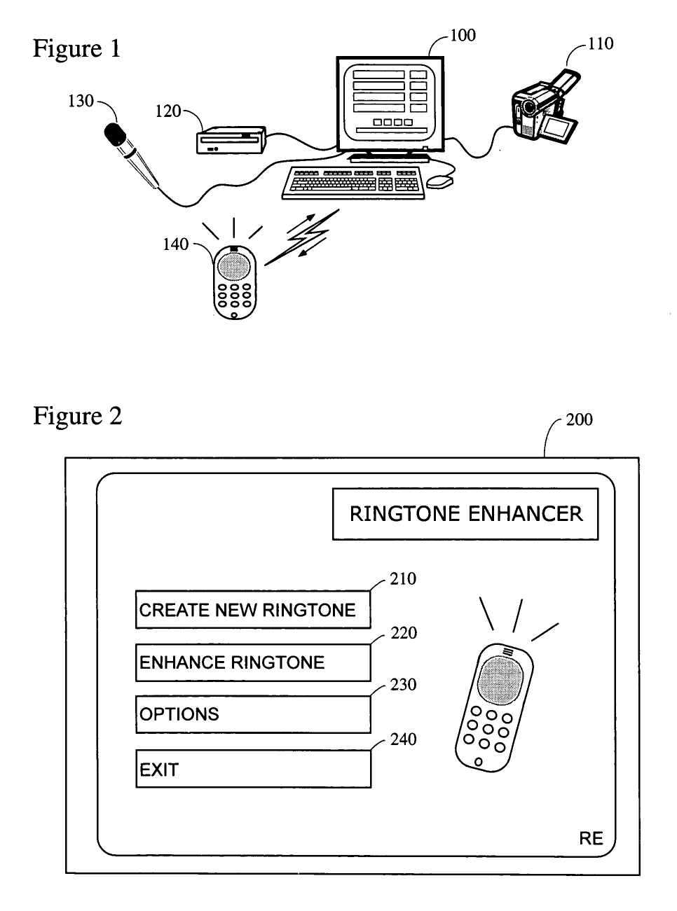

As is generally indicated in FIG. 1, at least a portion of the instant invention will be implemented in form of software running on a user's computer 100. Such a computer 100 will have some amount of program memory and hard disk storage (whether internal or accessible via a network) as is conventionally utilized by such units. Further, in some instances the software that implements the instant method will be executed on a portable computer running the Palm® or Windows CE® operating systems, to give some specific examples of handheld computer operating systems.

Additionally it is possible that an external camera 110 of some sort will be utilized with—and will preferably be connectible to—the computer so that video, audio and/or digital information can be transferred to and from the computer (FIG. 1). Preferably the camera 110 will be a digital video camera with audio capabilities, although that is not a requirement. Further, given the modem trend towards incorporation of cameras into other electronic components (e.g. in handheld computers, telephones, laptops, etc.) those of ordinary skill in the art will recognize that the camera might be integrated into the computer, the cell phone, or some other electronic device and, thus, might not be a traditional single-purpose video or still camera. Additionally, a microphone 130 might be utilized so that the user can record his or her own ringtones, whether vocal or instrumental. A CD or DVD burner 120 could be useful for reading and/or storing in-progress or completed works. Finally, in the preferred embodiment a cell phone 140 might be utilized which will be connected to the computer via—any of a variety of wired or wireless connection/transmission means, thereby allowing the computer to transfer information to and from the cell phone as needed.

Turning first to FIG. 2, in a preferred arrangement a user will be presented—with a computer GUI of the general form illustrated within the computer screen display 200. The user will preferably initially be provided with at least four menu options, each menu option preferably being designed to permit the user to access a different aspect of the instant invention. Preferably the user will be given the option of creating a new ringtone 210, editing an existing ringtone 220, modifying certain program options 230, and exiting 240 the program.

Selection of the options menu item 230 will preferably allow the user to modify settings that are used in the configuration of a program that implements the methods disclosed herein. For example, the user will preferably be able to define the connection settings for his or her cell phone, select a storage location for the enhanced ringtone, etc. The enhance ringtone 220 menu option will preferably allow the user to enhance a base ringtone that might be stored either on the cell phone or the users computer. In the preferred arrangement, by selecting menu item 220 a user will be able to enhance previously created ringtones, including those previously produced commercially, via the steps of the instant invention. Selection of the menu option 210 (i.e., create ringtone) will preferably activate the main part of the instant invention. Of course, those of ordinary skill in the art will recognize that interaction between the user and the computer will preferably be carried out via a GUI of the sort generally illustrated in the figures attached hereto and will likely take place with the assistance of keyboard or a mouse (or, e.g., a stylus in the case of a handheld computer).

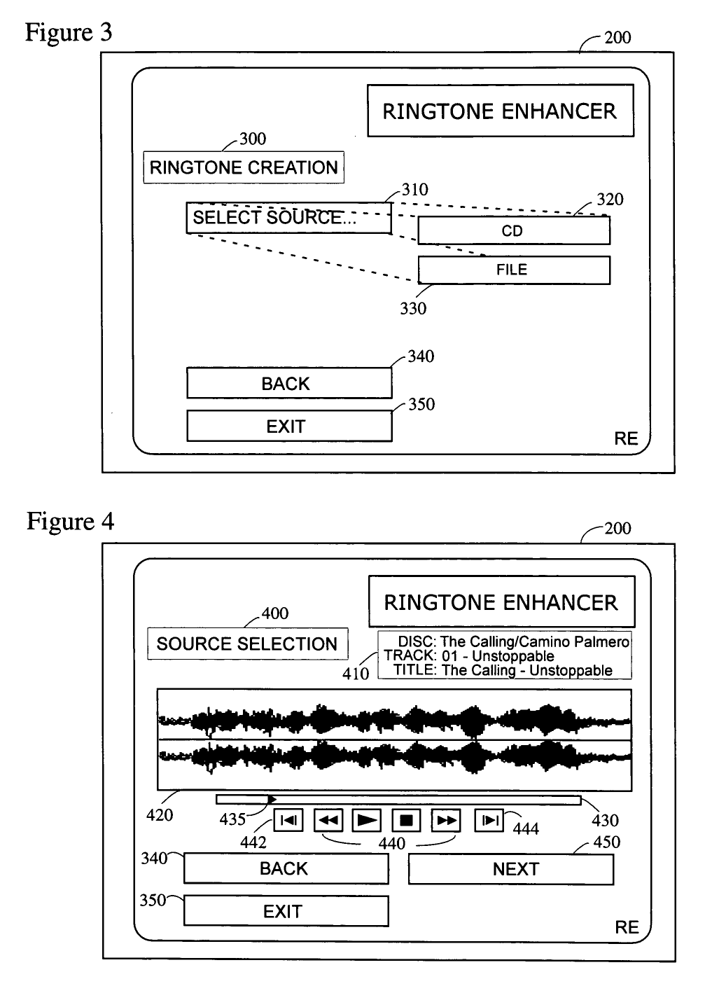

Turning next to FIG. 3, this figure illustrates how the screen of FIG. 2 might appear after the user has selected menu option 210 (i.e., create new ringtone). In the preferred arrangement, the user will be presented with an on-screen indicator 300 to signal which portion of the program is currently being executed.

As a first preferred step in this phase of the instant invention, the user will be prompted to select the digital source material 310 that is to be used as input. It is anticipated that provision will be made to allow the user to read input audio information at least from storage media such as CD 320 (preferably a music CD), and from a computer file 330. However, it should be noted that digital audio information might be stored in many different media types (e.g., RAM, flash RAM, ROM, DVD-R, DVD-RW, magnetic disk, optical disk, etc.) and, of course, the media listed previously are offered by way of example only. Additionally, it is preferred that the user be presented with navigation buttons that allow him or her to go back 340 to the previous step or to exit 350 the creation process. Preferably, the instant invention will automatically move forward into the next phase of the creation process after the user has selected the input source material.

FIG. 4 illustrates in more detail how one preferred aspect of the instant invention would appear after the user has selected the input source material. As is indicated in this figure, the user will preferably be informed about the current state of the creation process by onscreen indicator 400. Additionally, the GUI will preferably contain a variety of program options to support the user in the ringtone creation process. For example, one screen region 410 will preferably contain information that describes the selected audio source material, which information might include, for example, the file name, the disk name, and, in the event that an audio CD is the source, the track title and the disc title. The display of the input track name and disc titles will preferably not be modifiable by the user, but the user might be allowed to edit the title of the work to suit his or her own preference. Since, in the preferred arrangement, the title of the work will become the name of the enhanced ringtone on the user's computer, the advantage of allowing the user to modify this parameter should be clear.

A graphical representation of at least a portion of the input audio material 420 will preferably be displayed as part of the GUI. Additionally, and as is conventionally done, the GUI will also preferably contain a timeline section 430 with a navigation slider 435 which makes it possible for the user to quickly determine which part of the selected source material is visible on the screen at the moment. Of course, the timeline slider 435 will also allow the user to quickly move through the source material, thereby making it possible to find a sought-for section of the audio work in short order.

Preferably, controls such as the on screen transport controls 440 will be provided to further assist the user in preparing a ringtone according to the instant invention. These controls will preferably be styled to resemble their counterparts on a conventional VCR or DVD player and provide a familiar way for the user to use a computer mouse to control playback of the selected multimedia material. For example, it is preferred that controls such as rewind, play, stop, fast forward etc., be made available for use by the user. Those of ordinary skill in the art will recognize that such transport controls 440 are commonplace and well known in media editing programs. In addition to the transport controls 440, there will preferably be provided controls 442 and 444 that allow the user to set the starting 442 and ending 444 points of the current base ringtone within the input material.

Further, the preferred GUI will allow the user to go back 340 one step in the process of ringtone creation, to exit 350 the program, and to move forward 450 to the next step in the process. By requiring that the user utilize back 340 and next 450 buttons to control operation of the program, the program can help make certain that the user does not accidentally skip a step in the enhancement process.

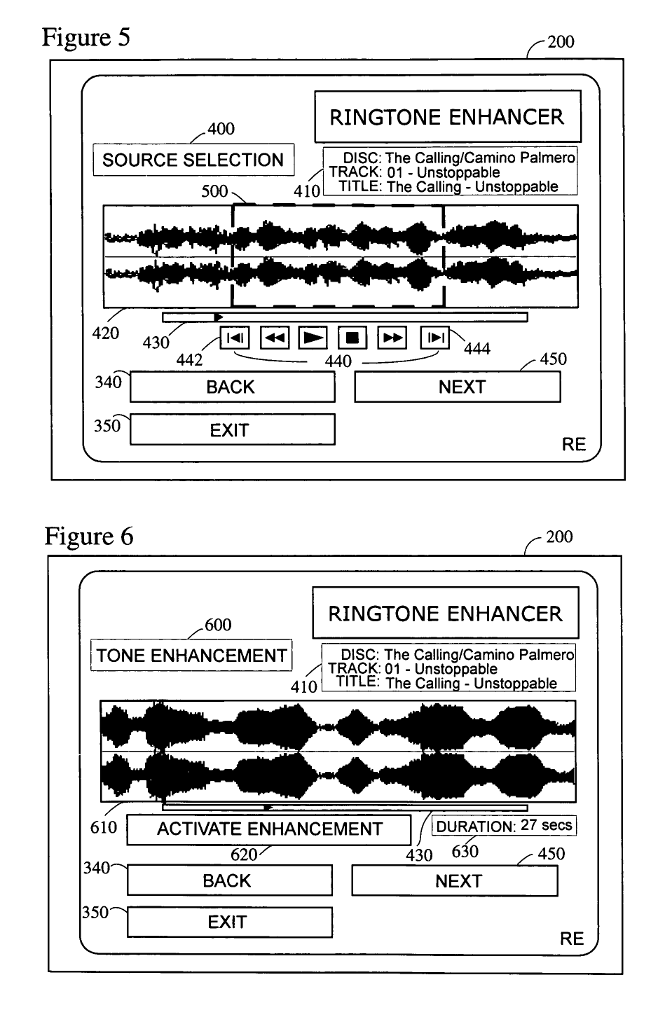

FIG. 5 illustrates the appearance of a preferred GUI of the instant invention after the user has selected the portion of the input audio source that is to serve as the base ringtone. The base ringtone is preferably visually outlined by a dotted rectangle 500 on the user's screen, although it should be noted that this sort of highlighting is given for illustrative purposes only and those of ordinary skill in the art will readily be able to devise alternative methods of displaying such a selection. Preferably, the dimensions of the selection rectangle 500 will be defined by the user via controls 442 and 444, wherein 442 is used to specify the starting point of the section and 444 is used to specify the endpoint. Preferably, the program that implements the instant invention will require the user to make some sort of selection on this screen before the “Next” button 450 can be activated, thereby assuring that some audio material will be available for analysis at the next step.

Turning next to FIG. 6, which illustrates another step in a preferred embodiment of the instant invention, after the input audio material has been selected and the desired subset of that input material (i.e., the base ringtone) has been indicated the instant invention will preferably proceed to the tone enhancement step. A preferred GUI that corresponds to this step is visually displayed in the graphical user interface that is illustrated in FIG. 6. The current step in the ringtone creation process is preferably displayed via on-screen indicator 600. Preferably, the general layout of the graphical user interface will remain the same, with the changes being described below.

Preferably the selected region 500 will be zoomed 610 to allow it to be viewed in greater detail, thereby allowing the user to more readily view the results of his or her definition step. In addition to the zoomed display 610, the GUI preferably will inform the user of the duration 630 of the desired section. It should be noted that during these steps the user will preferably always be able to go back to a previous step if current settings or definitions are not satisfactory. A key aspect of the preferred GUI is the user control 620 which allows the user to activate the enhancement of the selected section of the base ringtone.

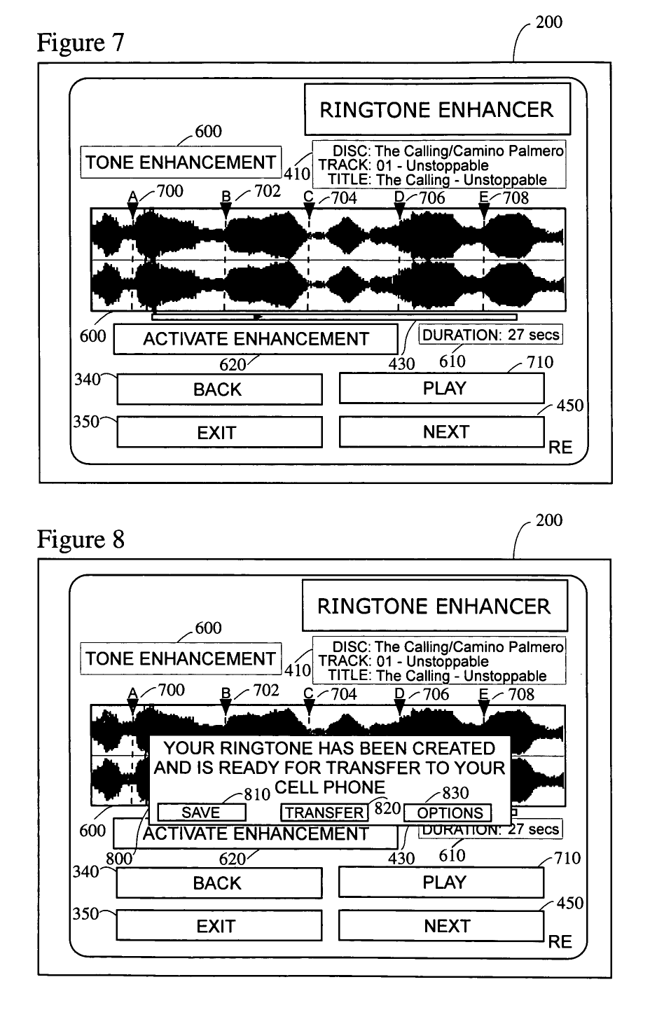

A preferred GUI that will be presented to the user after the completion of the tone enhancement step is displayed in FIG. 7. The tone enhancement step will preferably analyze the selected digital audio information to determine its rhythm and harmonics and is preferably divided into two phases: an analysis phase and a synthetic tone creation phase.

With respect to the analysis phase, a first preferred step is to apply an automatic beat detection algorithm to the base ringtone, one purpose of which is to identify the location of beats or other accented audio events within the work. Note that automatic beat detection is a standard feature in most audio editing programs and those of ordinary skill in the art are very familiar with such. Of course, knowledge of the beat structure also makes it possible to determine the tempo or rhythm of the audio work according to any number of well-known methods. However, in a preferred arrangement the beat detection algorithm will at least produce a beat grid (or a listing of beat locations) that is used in the third step of the analysis phase described hereinafter.

According to a second preferred step in the analysis phase, a continuous harmonic analysis will be performed on the input material. This analysis is preferably executed on the basis of band separated signals and redundancies between frequency bands in the ringtone. In more particular, in the preferred arrangement a Fourier Transform (preferably, a Fast Fourier Transform) will be calculated from the base ringtone. Next, the transformed data values will preferably be divided into at least four different frequency bands that, when taken together, span the range of frequencies in the base ringtone-. As a next preferred step, a table of note semitones and frequencies will be assembled that spans at least one octave (e.g., C1=261 Hz, C#=277 Hz, . . . C2=523 Hz., etc.) for each different frequency band Next, the four or more different frequency bands will preferably be stepwise analyzed for progressions in chord structure and harmony by identifying the presence of frequencies that correspond to the semitones in the table (or that correspond to the presence of frequencies that are separated from the assembled semitones by one or more octaves). By identifying frequencies in the calculated spectra that correspond to entries in the frequency table, it will be possible to obtain some estimate of the harmony, melody, or some other aspect of the base ringtone. Of course, given this information it will be possible to produce a time and pitch (note) series for each of the frequency bands.

As a next preferred step, the beat grid and the continuous harmonic analysis will be used to identify locations, durations, and pitches in the audio material that represent in some fashion the overall character of the work. For example, in some instances the results of this step will be an automatic determination of the melody of the work. In other instances, the bass line might be tracked, or the vocals, a lead instrument (e.g., guitar, flute, trumpet, etc.), etc.

Next, the time and pitch data obtained at the previous step will preferably be optimized via a dynamic optimization algorithm. By way of explanation, the preferred dynamic optimization method is a mathematical algorithm that seeks to identify and classify the harmonic progressions of the notes identified previously. Preferably, the optimization algorithm will be based on the dynamic programming work of Richard Bellman as his work has been applied to signal detection. Those of ordinary skill in the art will recognize that this approach is also sometimes referred to as dynamic time warping. In brief, the preferred algorithmic approach moves through the harmonics and notes identified previously by selecting an optimal path. Typically such a path will identify the melody or harmony of the source. The preferred dynamic optimization can also be described as a stepwise procedure that moves from a starting point sequentially through the notes by selecting as the next waypoint the note that creates a harmony that has the highest correlation stepwise with the target point.

Turning next to the synthetic tone generation phase of the instant invention, in the preferred embodiment the instant invention will next select or generate synthetic tones that are designed to match the time-data, amplitude, and pitches that have been determined previously. This will be done by selecting a voice (e.g., a sampled piano, a synthesized waveform, etc.) that will be used to sound the notes obtained previously, thereby producing the synthetic tones. Preferably, the notes that have been selected will be defined and stored using standard MIDI control codes or events (e.g., “note on”, “note off”, velocity, etc.) or some similar scheme for specifying note pitch, velocity, and duration. That being said, those of ordinary skill in the art will recognize that the synthetic tones might be created and stored in many different ways including, for example, storing such tones digitally as an MP3 or other digital audio file. Note that, in one preferred embodiment, the synthetic tones will be shifted (either up or down) so as to be two octaves higher than the actual representative notes which were produced by the analysis. In some embodiments this might be done so that the tones when sounded through the speaker would be within the frequency band that is most likely optimal for use on cell phones (e.g., between about 1,000 and 3,000 Hertz).

Although the synthetic tones obtained during the previous step might take many forms, in one preferred arrangement they will be voiced (i.e., expressed) by using computer generated waveforms such as sawtooth waves, sine waves, square waves, etc. In other variations, one or more sampled voices (e.g., piano, violin, orchestra, guitar, etc.) might be used to express each of the notes obtained previously. In still other variations, the synthetic tones might be voiced by using instruments that are within the General MIDI standard instrument set (e.g., pianos, horns, drums, etc.). In still another variation, rather than using the exact pitch obtained via the previous analysis, a complementary pitch (e.g., a pitch that is harmonious with the calculated pitch) will be used in order to make the ringtone more distinguishable. Of course, the conversion of the pitch/duration/amplitude information into a digital sound file might be accomplished in many way and those of ordinary skill in the art will be readily capable of devising alternative arrangements.

Turning now to FIG. 7, this figure contains a preferred representation of the GUI that will be presented to the user after the positions of the notes (and corresponding synthetic tones) have been determined. The time-positions of the synthetic tones 700 to 708 are preferably displayed adjacent to the zoomed portion of the base ringtone 600 using markers 700-708. Preferably, the user will be given the option of listening to the composite ringtone (i.e., the base ringtone played simultaneously with the previously determined synthetic tones) from this screen by selecting the “play” option 710.

If the user is satisfied with the result of the tone enhancement step he or she will preferably be able to select the “next” control 450. If the user is not satisfied with the result he or she will preferably be able to select the “activate enhancement” control 620 once again to instruct the instant invention to repeat the analysis that produced the current collection of notes/synthetic tones. In the preferred arrangement, the user might be given the option of keeping certain of the notes 700-708 and discarding others during the repeat analysis. In other variations, the user might be allowed to move to a new time location and/or change the pitch of one or more of the tones 700-708 before starting the revised analysis. In any case, it is expected that if the user does not elect to constrain the solution as described previously, the repeat analysis will typically not produce a synthetic tone series that is greatly modified from the first attempt.

FIG. 8 illustrates the appearance of a preferred GUI of the instant invention after the user has selected the “next” control 450. By activating this selection the user will preferably be able to indicate satisfaction with the positioning and pitch of the synthetic tones. In response to the selection of this program option, the instant invention will next preferably present the user with the information 800 that the enhanced ringtone has been created and offers several options. For example, according to one preferred option the user will be offered a chance to store 810 the enhanced ringtone on his or her local computer, to transfer 820 the enhanced ringtone to the users cell phone, etc. Additionally and preferably, the user will be given a chance to modify various other program options 830 such as, for example, the means by which the enhanced ringtone will be transmitted to the phone (e.g., wirelessly via Bluetooth, Wi-Fi, infrared, via a wired connection such as a USB cable, etc.). Those of ordinary skill in the art will recognize that there are many ways that a PC can transmit the enhanced ringtone to the cell phone and that the methods listed previously are given for purposes of illustration only.

Preferably the instant invention will transfer the enhanced ringtone as a single file to the user's cell phone. This might be, for example, an MP3 file that contains the algebraic sum of the original audio work and a (possibly rescaled) digital representation of the synthetic tones. However it is also possible that the synthetic tones and the original audio work might be transferred to the cell phone as separate files, with the expectation that software in the cell phone will play the two files simultaneously (e.g., one MP3 file and one MIDI file) to produce the desired effect.

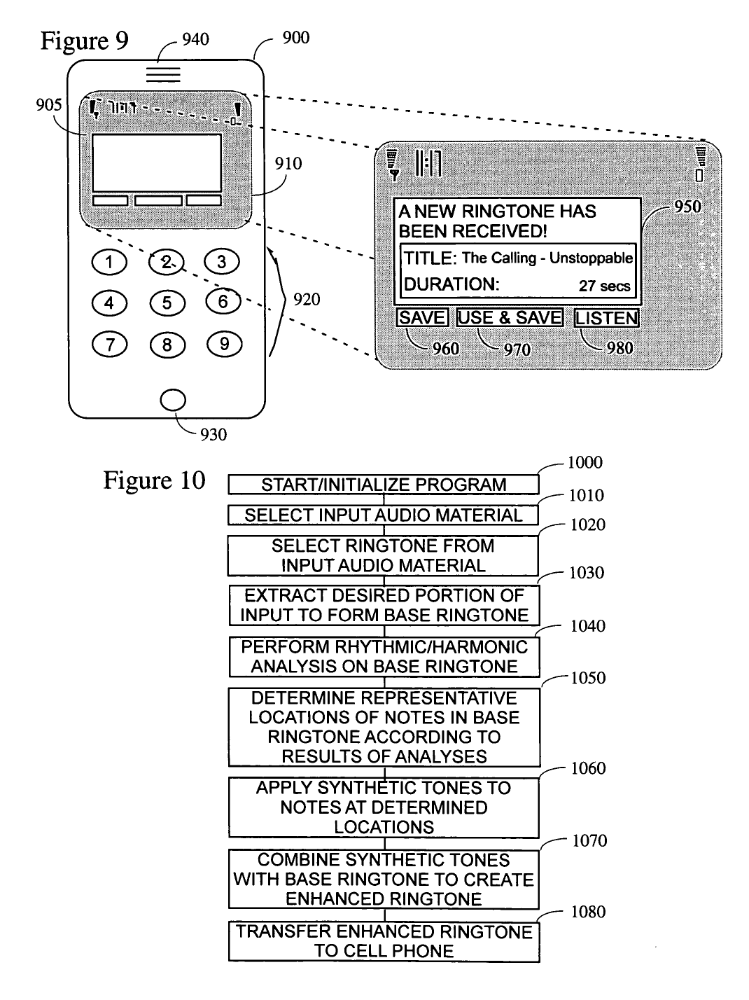

Turning next to FIG. 9, in this figure is illustrated a preferred general appearance of the user's cell phone screen 910 after it has received an indication that an enhanced ringtone is available for use. As is indicated in this figure, one preferred aspect of the instant invention will be carried out on a users cell phone 900. The cell phone will preferably have some amount of internal program memory and data storage (e.g. computer RAM) of the sort that is normally supplied with such units. Additionally it is anticipated that the cell phone will utilize a speaker 940 and a microphone 930. Note that the speaker 940 could take other forms including, for example, a separate pair of headphones connected by wire or wirelessly to the cell phone.

As is generally indicated in FIG. 9, a cell phone carrying out the instant invention will preferably contain software resident therein with menu choices 905 that are presented to the user via the cell phone display 910. As indicated in FIG. 9, in a preferred arrangement a user will interact with the instant invention by way of the graphical display 910 of the cell phone and additionally with the use of the standard telephone keypad 920, or alternatively, the various special purpose/reprogrammable keys that are often provided. Finally, many cell phones and other devices utilize “soft keys” which are graphical representations of buttons that are drawn on the display device 910 and which could also be used to receive instructions from a user. Those of ordinary skill in the art will recognize that interaction with a user can take place via any number of methods and/or devices (to include the use of peripherals that have been attached to the cell phone) and such interactions are not limited to the use of the physical buttons that might be present on the face of the selected device.

FIG. 9 displays a preferred representation of a message that would be suitable to inform the cell phone owner of the receipt of a new enhanced ringtone. Preferably, the user will be informed that a new ringtone has been received by an audible alarm and/or notification 950 on the screen of the cell phone. Additionally, the user will also preferably be informed of the ringtone title and duration. Preferably the user will be presented with options of the general sort illustrated in FIG. 9 including, for example, options that allow the user to save (e.g., store in the internal memory of the cell phone) 960, use and save 970, and listen to (without saving) 980 the recently received enhanced ringtone.

FIG. 10 illustrates a preferred workflow of the instant invention. As a first preferred step 1000, a program that embodies the instant invention will be started and initialized according to methods well known to those of ordinary skill in the art. Next the user will preferably be asked to select the input audio material 1010, wherein the input material might potentially be any sort of digital audio data, although it will preferably be some sort of music that is read from, for example, hard disk, an audio CD, a DVD (to include a DVD audio disk), etc. As a next preferred step, the user will select 1020 all or a portion of the input audio material for use a ringtone, i.e., the base ringtone. In a preferred embodiment the user will be presented with the entire audio work and allowed to select (e.g., via a mouse-drive GUI) that portion of the work that is to be the basis for an enhanced ringtone.

After the user has selected the audio data that is to form basis for the ringtone, the instant invention will preferably next extract the desired section 1030 from the input audio material and then just that portion will be presented to the user in a zoomed or expanded view, so that the user can control his or her selection more accurately.

As a next preferred step the instant invention will automatically perform a rhythmic and harmonic analysis 1040 of the base ringtone. As was described previously, this analysis will preferably involve the application of three separate algorithms. To recap, first an automatic beat detection is preferably performed on the input material. The results of the beat detection will next be used to create a beat grid. Next, a continuous harmonic analysis will preferably be performed. The harmonic analysis will preferably be based on band-separated signals of the input materials and redundancies between the bands. This beat locations and harmonies will then preferably be optimized via a dynamic optimization step.

Based on the foregoing, the instant invention will next preferably define note pitches, positions, and durations (step 1050) within the audio work at which synthetic tones will be applied. Preferably, the synthetic tones will be selected so as to be a fit with the musical characteristics of the underlying ringtone. In the preferred embodiment, the synthetic tones will be chosen to emphasize the harmonic features (e.g., the melody) of the selected section.

As a next preferred step, the synthetic tones will be incorporated 1060 into the selected ringtone at the time points determined previously and offered to the user for review. If the placement of the synthetic tones at these locations is acceptable, the instant invention will preferably digitally combine the synthetic tones with the input material, thereby creating an enhanced ringtone 1070. Note that, as has been described previously, the enhanced ringtone need not necessarily be combined into a single file at this point but, instead, might be maintained as two separate files that are designed to be played simultaneously (in synchronization) as needed on the cell phone. Of course, if the user is not satisfied with the placement, duration, or pitch of the synthetic tones he or she can choose to have the analysis steps performed again, with or without placing constraints on the solution.

Finally, and as a next preferred step 1080, the instant invention will preferably transfer the enhanced ringtone to the user's cell phone. This transfer will preferably be carried out using a user-specified communication protocol, after which the ringtone will be available for use in signaling the phone's owner.

### Conclusions

Of course, many modifications and extensions could be made to the instant invention by those of ordinary skill in the art. For example, in one preferred arrangement it will be possible to specify the length of the ringtone that is extracted from the audio work rather than using a mouse-driven GUI to select the relevant section on the screen. For example, the user could specify that the ringtone should consist of the first few (e.g., 15), last few, etc., seconds of the selected audio work. In other variations, the user might be allowed to select multiple input files and digitally combine them before subjecting them to the beat and harmonic analyses discussed herein. In other embodiments, the analyses of multiple input files would each be done separately with the multiple works being combined into a single ringtone (and single synthetic tone series) only after the synthetic tones have been separately determined for each work. Finally, some preferred embodiments will allow the user to apply standard signal processing effects/algorithms (e.g., filtering, flanging, applying reverb, etc.) to the ringtone before the synthetic tones are determined.

Note also that although the instant invention is especially well suited for use within cellular telephones, that is not its only possible application. More generally, the instant method would be well suited for use with any sort of mobile computing device that has some sort of (likely low quality) speaker integral thereto and that uses audio information to signal to a user when a predetermined event occurs. For example, in the event that the mobile computing device is a cell phone, the event might be the receipt of an incoming call or a text message. In the event that the computing device is a hand held computer, the event might be expiration of a timer. Those of ordinary skill in the art will be readily able to formulate alternative uses for the instant invention.

Further, those of ordinary skill in the art will recognize that although the intended use for the enhanced ringtones is within a cellular phone to notify a user of cell phone events, other variations are certainly possible. In more particular, in the event that the base work is an entire song (rather than just a few seconds of it), it would certainly be possible to create an enhanced version of that song using a straightforward application of the methods discussed herein. As before, synthetic tones would be created that complement the musical work and are designed to be played simultaneously with it. The synthetic tones and the original musical work would be combined (either in advance or during a performance) to produce a unified musical work.

Finally, although the instant method is well suited for use with low fidelity speakers, it should be clear that this is not an absolute requirement. In some circumstances, a user might prefer to play the enhanced work through a high fidelity speaker system, and that would be especially true where an entire musical work has been enhanced as was described previously herein.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those skilled in the art, without departing from the spirit of the inventive concept the scope of which is to be determined by the following claims.

What is claimed is:

1. A method of giving notice of a cell phone event, comprising the steps of:
a. selecting a digital base ringtone;
b. using said base ringtone to select a plurality of synthetic tones, said synthetic tones being representative of an aspect of said base ringtone;
c. recognizing the cell phone event within a cell phone;
d. within said cell phone simultaneously performing said base ringtone and said plurality of synthetic tones through a cell phone speaker, thereby giving notice of the cell phone event.

2. A method of giving notice of a cell phone event according to claim 1, wherein the event is an incoming call within said cell phone.

3. A method of giving notice of a cell phone event according to claim 1, wherein said representative aspect of said base ringtone is selected from a group consisting of a melody of said base ringtone, and a harmony of said base ringtone.

4. A method of giving notice of a cell phone event according to claim 1, wherein step (d) comprises the steps of:
(d1) digitally combining said base ringtone and said synthetic tones into a single digital work, thereby forming an enhanced ringtone,
(d2) transmitting said enhanced ringtone to said cell phone,
(d3) within said cell phone performing said enhanced ringtone through a cell phone speaker, thereby notifying the user of said event.

5. A method of giving notice of a cell phone event according to claim 4, wherein step (d1) comprises the steps of:
(i) obtaining a digital representation of said synthetic tones,
(ii) numerically summing together said base ringtone and said digital representation of said synthetic tones into a single digital work, thereby forming an enhanced ringtone.

6. A method of giving notice of a cell phone event according to claim 4, wherein step (d2) comprises the steps of:
(i) transmitting said enhanced ringtone to said cell phone via a wireless communications protocol.

7. A method of giving notice of a cell phone event according to claim 6, wherein said wireless communications protocol is selected from a group consisting of an IR communications protocol, a Bluetooth communications protocol, and a Wi-Fi communications protocol.

8. A method of giving notice of a cell phone event according to claim 1, wherein step (b) comprises the steps of: synthetic tones comprises a series of MIDI note events.
(i) using said base ringtone to obtain a plurality of pitches and durations, said pitches and durations being representative of an aspect of said base ringtone,
(ii) representing said plurality of pitches and durations as a plurality of MIDI events,
(iii) converting said plurality of MIDI events to a plurality of synthetic tones, wherein said synthetic tones are representative of said aspect of said base ringtone.

9. A method of creating an enhanced ringtone for use in a mobile computing device having at least one speaker, comprising the steps of:
a. selecting a base ringtone;
b. using said base ringtone to select a plurality of synthetic tones, said synthetic tones being representative of at least one aspect of said base ringtone;
c. digitally combining said base ringtone and at least a portion of said synthetic tones to create said enhanced ringtone, so that when said enhanced ringtone is played said base ringtone and said at least a portion of said synthetic tones are played simultaneously; and,
d. storing said enhanced ringtone within said mobile computing device.

10. A method of creating an enhanced ringtone according to claim 9, further comprising the step of:
e. within said mobile computing device, receiving notification of an event; and,
f. playing said enhanced ringtone through the speaker to notify a user of said event notification.

11. A method of creating an enhanced ringtone for use in a mobile computing device according to claim 9, wherein said mobile computing device is selected from a group consisting of a cellular telephone, a PDA, and a handheld computer.

12. A method of creating an enhanced ringtone according to claim 10, wherein said mobile computing device is a cellular telephone and said event is an incoming cellular phone call.

13. A method of creating an enhanced ringtone according to claim 9, wherein said representative aspect of said base ringtone is selected from a group consisting of a melody of said base ringtone, and a harmony of said base ringtone.

14. A method of creating an enhanced ringtone according to claim 9, wherein step (d) comprises the steps of:
(d1) digitally combining said base ringtone and said synthetic tones into a single digital work, thereby forming an enhanced ringtone,
(d2) transmitting said enhanced ringtone to said cell phone,
(d3) within said cell phone performing said enhanced ringtone through a cell phone speaker, thereby notifying the user of said event.

15. A method of creating an enhanced ringtone for use in a mobile computing device according to claim 9, wherein said mobile computing device has an amount of RAM integral thereto, and wherein step (d) comprises the step of:
(d1) storing said enhanced ringtone within said mobile computing device within said mobile computing device RAM.

16. A method of creating an enhanced ringtone for use in a mobile computing device according to claim 15, wherein said mobile computing device RAM is nonvolatile RAM.

17. A method of creating an enhanced musical work according to claim 9, wherein step (b) comprises the steps of:
(i) performing a beat analysis on said base musical work, thereby obtaining a beat grid of said base musical work,
(ii) performing a continuous harmonic analysis of said base musical work,
(iii) dynamically optimizing said beat grid and said harmonic analysis, thereby producing a series of notes representative of an aspect of said base musical work, and,
(iv) voicing said series of notes, thereby producing a plurality of synthetic tones designed to be played simultaneously with said base musical work.

18. A method of creating an enhanced musical work according to claim 17, wherein (iv) comprises the step of:
(1) voicing said series of notes by selecting at least one waveform source for use in expressing said series of notes, thereby producing a plurality of synthetic tones designed to be played simultaneously with said base musical work.

19. A method of creating an enhanced musical work according to claim 18, wherein said at least one waveform source is selected from a group consisting of a sawtooth wave, a square wave, a sine wave, a sampled piano, a sampled horn, a sampled violin, and a sampled orchestra,

20. A method of creating an enhanced musical work, comprising the steps of:
a. selecting a base musical work;
b. using said base musical work to select a plurality of synthetic tones, said synthetic tones
(b1) being representative of an aspect of said base musical work, and
(b2) being designed to be played simultaneously with said base musical work;
c. combining said base musical work and said synthetic tones into a unified musical work, thereby creating said enhanced musical work;
d. performing said enhanced musical work through a speaker, thereby creating an audible representation of said enhanced musical work.

21. A method of creating an enhanced musical work according to claim 20, wherein step (b) comprises the steps of:
(i) performing a beat analysis on said base musical work, thereby obtaining a beat grid of said base musical work,
(ii) performing a continuous harmonic analysis of said base musical work,
(iii) dynamically optimizing said beat grid and said harmonic analysis, thereby producing a series of notes representative of an aspect of said base musical work, and,
(iv) voicing said series of notes, thereby producing a plurality of synthetic tones designed to be played simultaneously with said base musical work.

22. A method of creating an enhanced musical work according to claim 21, wherein (iv) comprises the step of:
(1) voicing said series of notes by selecting at least one waveform source for use in expressing said series of notes, thereby producing a plurality of synthetic tones designed to be played simultaneously with said base musical work.

23. A method of creating an enhanced musical work according to claim 22, wherein said at least one waveform source is selected from a group consisting of a sawtooth wave, a square wave, a sine wave, a sampled piano, a sampled horn, a sampled violin, and a sampled orchestra.
